(19) United States
(12) Patent Application Publication
(10) Pub. No.: US 2022/0003254 A1
(43) Pub. Date: Jan. 6, 2022

(54) QUICK PLUG-IN FASTENER

(71) Applicant: Ferdinand Müller-Niksic, Waldbröl (DE)

(72) Inventor: Ferdinand Müller-Niksic, Waldbröl (DE)

(21) Appl. No.: 17/291,403

(22) PCT Filed: Nov. 4, 2019
(86) PCT No.: PCT/DE2019/000289

§ 371 Date: May 5, 2021

(30) Foreign Application Priority Data
Nov. 6, 2018 (DE) 10 2018 008 709.4

(51) Int. Cl. F16B 2/10

(52) U.S. Cl. CPC F16B 2/10; F16B 7/0426

(57) ABSTRACT

A fastener comprises a receiving part comprising a housing defining a recess configured to receive a head of a plug-in part. The housing comprises at least two locking legs bordering the recess and pivotably mounted on the receiving part. The at least two locking legs each comprise an locking legs and extending along a spring axis. Movement of each actuating section toward each other acts to compress the spring member and open the recess to define an unfastened state. Once the head is inserted into the recess, release of each actuation section enables the spring member to exert a force along the spring axis to push the actuation sections away from each other and move each locking leg section to engage and retain the head to define a fastened state.

### CROSS REFERENCE TO RELATED APPLICATIONS

This application is a national stage application pursuant to 35 U.S.C. § 371 of International Application No. PCT/DE2019/000289, filed on Nov. 4, 2019, which claims priority to and benefit of, German Patent Application No. 10 2018 008 709.4, filed Nov. 6, 2018, the entire contents of which are hereby incorporated by reference.

### BACKGROUND

Plug-in fasteners are used to connect ropes, bells, rods, devices, machines, and the like. Such fasteners are cumbersome and difficult to use. The present invention relates to an alternative plug-in fastener and more specifically a quick plug-in fastener that provides a particularly secure connection with particularly easy handling.

### BRIEF SUMMARY OF THE INVENTION

An embodiment of a quick plug-in fastener comprises a receiving part with a housing with a recess therein for receiving a mushroom shaped head of a plug-in part. The housing comprises at least two wall sections formed by movable locking legs bordering the recces and that are pivotably mounted on the receiving part and have actuating sections which release the recess from the locking legs against a spring force by the manual or automatic inward movement to introduce a plug-in pail and, by an automatic outward movement, assume a position constricting the recess by a projecting locking leg section, and with a plug-in part with a mushroom-shaped head that is hooked by the leg sections when in the state inserted into the recess and strikes, by a contact surface, against a connecting surface of the receiving part.

In an embodiment, when the receiving part is in the initial position, the locking legs assume a position in which their projecting locking leg sections engage in the recess by spring pressure and constrict it. When the mushroom head of the plug-in pan is inserted into the recess of the receiving part, the projecting locking leg sections are pressed by the mushroom head radially outward against the spring force so that the mushroom head can move past them into its end position in the recess. When the mushroom head has passed the projecting locking leg sections, they snap back by spring force and lock the mushroom head in its locked position. In so doing, a contact surface of the plug-in part strikes a connecting surface of the receiving part so that the plug-in part, when in this locked position, lies tightly against the housing of the receiving part.

To open the fastener, the actuating sections of the locking legs are moved radially inward manually or also automatically, whereby the projecting locking leg sections of the locking legs are moved radially outward and release the mushroom head of the plug-in part so that the plug-in part can be pulled out of the recess of the receiving part.

The locking legs are configured and arranged so that they preferably form a part of the housing wall of the receiving part, wherein they preferably end Hush with the outside of the housing wall, i.e., do not project radially outward from the housing, at least in their initial position. In an embodiment, the locking legs are configured so that they extend obliquely to the outside by their actuating sections from the remaining part of the legs. The actuating sections therefore can be moved radially inward manually in an easy and convenient manner.

Overall, the configuration therefore preferably results in which the locking legs are pivotably mounted on the housing of the receiving part, wherein the corresponding pivot point is preferably located at the top housing end, and the actuating sections of the locking legs extend obliquely upward from there, whereas those sections of the locking legs extend downward from the pivot point that form corresponding wall sections of the housing of the receiving part.

In an embodiment, the actuating sections of the locking legs are braced by spring members or springs on the housing of the receiving part. In the initial position or unfastened position, the spring members engage or press the actuating sections radially outward. Upon being compressed, the actuating sections move against the spring forces radially inward and, upon being released, are automatically pressed radially outward back into their initial position. The receiving part and the plug-in part are provided with connections for ropes, belts, rods, devices, machines, and the like lo be connected. These connections can be column-like extensions of the housing of the receiving part as well as the mushroom head of the plug-in part that, if applicable, may be provided with suitable fixing means in order to fasten ropes, etc. . . . In an embodiment, the recess of the receiving part possesses an at least partially conically shaped inner wall. This inner wall is adapted to the shape of the mushroom head of the plug-in part. In an embodiment, the housing of the receiving part is preferably designed cylindrical.

In an further embodiment, when in a fastened state, a contact surface of the plug-in part strikes against a connecting surface of the receiving part, or respectively lies against it. Such a contact surface of the plug-in part is preferably located on a collar surrounding a column of the plug-in part. This collar is arranged under the mushroom head and therefore, when in a fastened stale, lies against the bottom connecting surface of the housing of the receiving part.

### BRIEF DESCRIPTION OF THE DRAWINGS

The invention will be explained in detail below with reference to an exemplary embodiment in conjunction with the drawing. In the figures:

FIG. 1 illustrates a schematic cross-sectional view of an embodiment of a quick plug-in fastener in a first position; and

FIG. 2 illustrates a schematic cross-sectional view of the embodiment of the quick plug-in fastener from FIG. 1 in a second position.

### DETAILED DESCRIPTION OF THE INVENTION

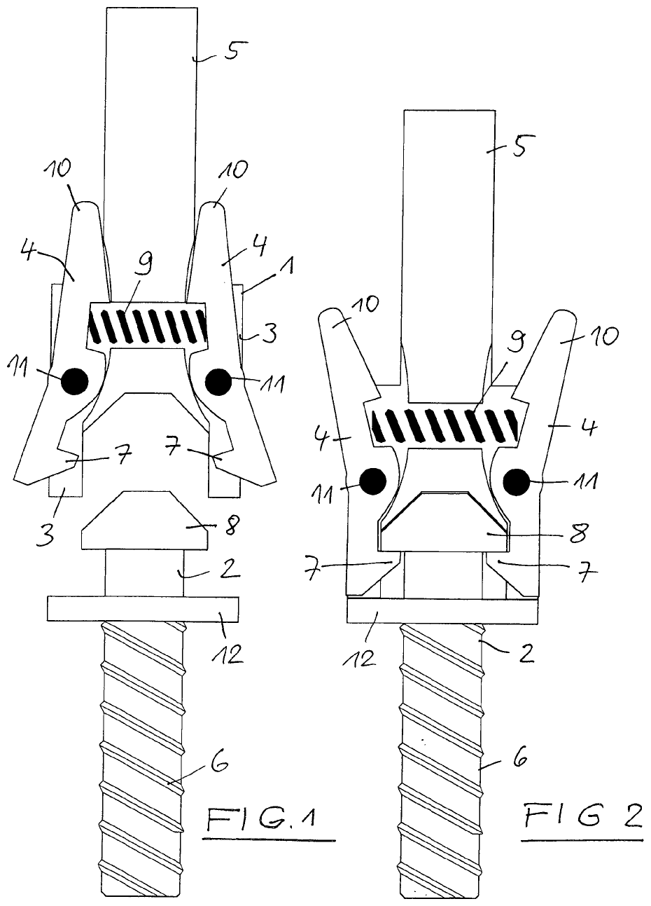

Referring to FIG. 1, the depicted quick plug-in fastener possesses a receiving part 1 with a housing 3 in which a plug-in part 2 can be inserted. FIG. 1 shows the plug-in part 2 in an uninserted state. Receiving part 1 and plug-in part 2 possess column-like attachments that are provided with suitable fixing apparatuses for connecting ropes, belts, rods, etc. as only schematically indicated at 5 and 6.

The receiving part 1 is furthermore provided with two locking legs 4, by the actuation of which the fastener can be opened and closed. These locking legs 4 each form a section of the w all of the housing 3 and extend by actuating sections 10 upward out of the housing 3. By manually moving the actuating sections 10 radially inward, the fastener is opened. By releasing the actuating sections 10, they are moved back by spring pressure into their initial position depicted in FIG. 1.

FIG. 2 shows the plug-in part 2 in an inserted state. It can be seen that a spring 9 mounted in the housing 3 presses the actuating sections 10 of the locking legs 4 radially outward, whereby locking sections 7 projecting radially inward of the locking legs 4 that are pivotably mounted at 11 are pressed radially inward. FIG. 2 shows a slate in which a plug-in part 2 with a mushroom head 8 has been inserted into a corresponding recess in the housing of the receiving part. In this state, the projecting locking leg sections 7 hook behind the mushroom head 8, w herein a plate-shaped section 12 of the plug-in part 2 lies against the bottom side of the housing of the receiving part.

To open the fastener, the two actuating sections 10 of the locking legs 4 are moved radially inward, whereby the projecting locking leg sections 7 are moved radially outward. This allows the plug-in part 2 to be pulled downward out of the recess in the housing 3. By releasing the actuating sections 10, the projecting locking leg sections 7 return back to their initial position in which they form a part of the wall of the housing 3 of the receiving part 1.

1-8. (canceled)

9. A fastener comprising:
a receiving part comprising a housing defining a recess configured to receive a head of a plug-in part, wherein the housing comprises,
at least two locking legs bordering the recess and pivotably mounted on the receiving part, wherein each of the at least two locking legs comprises,
an actuating section, and
a locking leg section, and
a spring member positioned between the at least two locking legs and extending along a spring axis.
wherein movement of each actuating section toward each other acts to compress the spring member and open the recess to enable the head of the plug-in part to be inserted into the recess and thereby defining an unfastened state, and
wherein, once the head is inserted into the recess, release of each actuation section enables the spring member to exert a force along the spring axis to push the actuation sections away from each other and move each locking leg section to constrict the recess and engage and retain the head of the plug-in pail to define a fastened state,
wherein the receiving part is coupled to one of: (1) a rope; (2) a belt; and (3) a rod to be connected.

10. The fastener according to claim 9, wherein in the fastened state, the actuating sections of the at least two locking legs extend obliquely upward and away from the one of: (1) the rope; (2) the belt; and (3) the rod coupled to the receiving part.

11. The fastener according to claim 9, wherein the at least two locking legs are pivotably mounted on the housing of the receiving part.

12. The fastener according to claim 9, wherein the actuating sections of the at least two locking legs are engaged by the spring member.

13. The fastener according to claim 9, wherein in the unfastened state, the at least two locking legs form a part of the housing of the receiving part.

14. The fastener according to claim 9, wherein the recess of the receiving part comprises an inner wall, and wherein the inner wall comprises a shape that is at least partially conical.

15. The fastener according to claim 9, wherein the housing of the receiving part comprises a cylindrical shape.

16. The fastener according to claim 9, wherein in the fastened state, a contact surface of the plug-in pan strikes against a connecting surface of the receiving part, and wherein the contact surface of the plug-in part is located on a collar surrounding a column of the plug-in part.
